(19) United States
(12) Patent Application Publication
(10) Pub. No.: US 2006/0153013 A1
(43) Pub. Date: Jul. 13, 2006

(54) Method and apparatus for reading and recording information on a rewritable record carrier

(76) Inventors: Erwin Rinaldo Meinders, Eindhoven (NL); Ruud Vlutters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/561,850

(22) PCT Filed: Jun. 30, 2004
(86) PCT No.: PCT/IB04/51063

§ 371 Date: Dec. 21, 2005

(30) Foreign Application Priority Data
Jul. 3, 2003 (EP) 03101994.6

(51) Int. Cl. G11B 11/00

(52) U.S. Cl. 369/13.54

(57) ABSTRACT

The present invention relates to a method and a corresponding device for recording data in the form of marks and for erasing recorded marks in an information layer of a record carrier by irradiating the information layer by means of a pulsed radiation beam, a recorded mark being erased by a sequence of erase pulses (31, 32), said information layer having a phase reversibly changeable between a crystalline phase and an amorphous phase. In order to achieve a significant reduction in power consumption, which is at least important for portable optical drives such as an SFFO drive, it is proposed according to the present invention that at least one of the erase pulses in said sequence of erase pulses (31, 32) has an erase power level which is decreasing with time. The present invention also relates to a method and a device for reading information from a record carrier.

The present invention relates to a method and a corresponding apparatus for recording data in the form of marks and for erasing recorded marks in an information layer of a record carrier by irradiating the information layer by means of a pulsed radiation beam, a recorded mark being erased by a sequence of erase pulses, said information layer having a phase reversibly changeable between a crystalline phase and an amorphous phase. The present invention relates further to a method and a corresponding apparatus for reading data recorded in the form of marks and spaces in an information layer of a record carrier by irradiating the information layer by means of a sequence of read pulses of a pulsed radiation beam.

Power consumption in portable devices is a major issue. Although the lifetime of nowadays batteries have significantly improved, extension of the operation time of portable devices is always pursued. The small form-factor optical disc (SFFO) is a rewritable drive suitable for all kind of handheld devices. The SFFO system is based on Blu-ray Disc (BD) technology and uses a blue laser, such as a blue laser diode, for writing data in a recording medium. A typical BD laser power strategy consists of write power, cooling gaps with a low laser power (bias level), erase power and read power. In all cases the laser diode is on, the laser output being very small (typically 0.1 mW for the bias level) to quite high (about 10 mW for writing). These numbers constitute only 10% of the total consumed laser diode power since a huge threshold current is involved. To reduce the laser power consumption, advanced write strategies were proposed in which the laser diode is totally switched off and are not kept at bias level. However, the total switching-off of the laser current results in less steep pulse responses.

It is an object of the present invention to provide a recording method and apparatus as well as a reading method and apparatus by which a reduced laser power consumption can be obtained, in particular when applied in portable optical devices such as an SFFO drive.

This object is achieved according to the present invention by a method as claimed in claim 1, according to which at least one of the erase pulses in said sequence of erase pulses has an erase power level which is decreasing with time. A corresponding device comprising radiation source and a control unit is defined in claim 9.

Erase pulses are typically applied in between pulse trains of write pulse to erase old marks in case of phase-change recording. In most applications, the erase power is a DC kind of signal and the level is constant. It is known that a pulsed erase strategy minimizes the temperature leakage to the adjacent tracks (heat leakage to the adjacent tracks was a problem that was encountered in the development of blue land/groove recording (the former technology of Blu-ray Disc). The present invention relates to a modification of such a pulsed erase strategy in order to minimize power consumption, particularly in a portable device (SFFO).

A block-shaped pulse typically results in a steady temperature increase, which is very characteristic for a pulse response (although the linear recording velocity is now involved). An upwards staircase leads to a somewhat delayed temperature increase, causing an even steeper temperature rise. A downwards staircase leads to the opposite and wanted behavior, namely a more or less constant and lower temperature in time. This behavior can be understood from the insight that a high laser power is applied when the temperature of the medium is low. After the first time increment in which the laser power is on, the recording stack heats up, and the laser power is reduced accordingly to compensate for the increasing temperature.

Preferred embodiments of the invention are defined in the dependent claims. One possibility is to use erase pulses having the shape of a downwards staircase, i.e. wherein at least one of the erase pulses in said sequence of erase pulses consists of n portions, n being an integer number larger than 1, the i-th portion having an i-th erase power level, i being an integer number in the range between 1 and n, the i-th portion preceding the (i+1)-th portion, and wherein the i-th erase power level is higher than the (i+1)-th erase power level. Preferably, at least one of the erase pulses in said sequence of erase pulses consists of n portions of substantially the same duration. Parameters like the numbers of steps, the step size, duration etc. depend very much on the record carrier, in particular the number of information layers, the material used and the thicknesses thereof, and the recording velocity. In general, the number of steps could be between 2 and N, N being at least 20. The step size could be between 2 and 99% of the highest erase power level, preferably between 5 and 10%.

According to another embodiment at least one of the erase pulses in said sequence of erase pulses has an erase power level that is continuously decreasing with time. The decrease thus could have a ramp-shaped form, wherein the decrease is linear. However, also other decrease shapes could be used, such as a parabolic decrease with time.

Generally, a ramp-shaped trailing edge is more preferred to a stair-shaped edge; however, but a staircase is the logical consequence of limited time resolution. Since the number of discrete levels is limited in optical recording devices, a compromise is typically pursued between dynamic resolution (number of power levels) and the number of time increments. In some optical recording devices, write strategy optimisation is done in the time domain, fine tuning of writing behaviour by time shifts, in other devices, fine tuning is done by fine tuning the power levels. Therefore, in some cases, the time resolution forces the definition of a staircase behaviour instead of the ramp. However, a deviated profile, like an exponentially decreasing power may also be beneficial in some cases, for example at ultra-high speed recording.

It is further preferred that all erase pulses in said sequence of erase pulses have an erase power level which is decreasing with time. However, it is also possible that only a single or several single erase pulses have an erase power level decreasing with time while other erase pulses in the same sequence of erase pulses have a constant erase power level. Moreover, in order to make control as easy as possible all erase pulses in one sequence of erase pulses can be made identical.

It is also possible that the front portions of the erase pulses in one sequence of erase pulses have different erase power levels, i.e. the erase pulses in one sequence start with different height. Furthermore, all erase pulses could have different step durations and step sizes, or different shapes of decrease.

The erase power level can also be controlled depending on the properties of the record carrier and the erasing velocity in order to apply the best possible erase strategy for the respective record carrier and erasing velocity.

The object of the invention can also be achieved by an optical recording device as claimed in claim 9 comprising a radiation source for providing the radiation beam and a control unit operative for controlling the power of the radiation beam and for providing a sequence of write pulses for recording the marks and a sequence of erase pulses for erasing recorded marks. The control unit is further operative for controlling the power of the radiation beam for erasing a recorded mark such that at least one of the erase pulses in said sequence of erase pulses has an erase power level which is decreasing with time. The control unit can be implemented by generally known analogue or digital devices. Furthermore, the control unit can also be implemented by a programmable signal processing unit programmed by an appropriate computer program.

A downward staircase pulse shape can also be used to improve the repeated read performance of a disc. In that case, the total read power can be reduced without sacrificing the signal-to-noise ratio of the signals received from the record carrier. It is well known that a reduced read power improves the number of read cycles, which means that deterioration of the written marks is severely postponed. An appropriate method for reading information from a record carrier according to the invention is defined in claim 10. A corresponding apparatus is defined in claim 18. Preferred embodiments thereof are defined in dependent claims.

The present invention will now be explained in more detail with reference to the drawings, in which

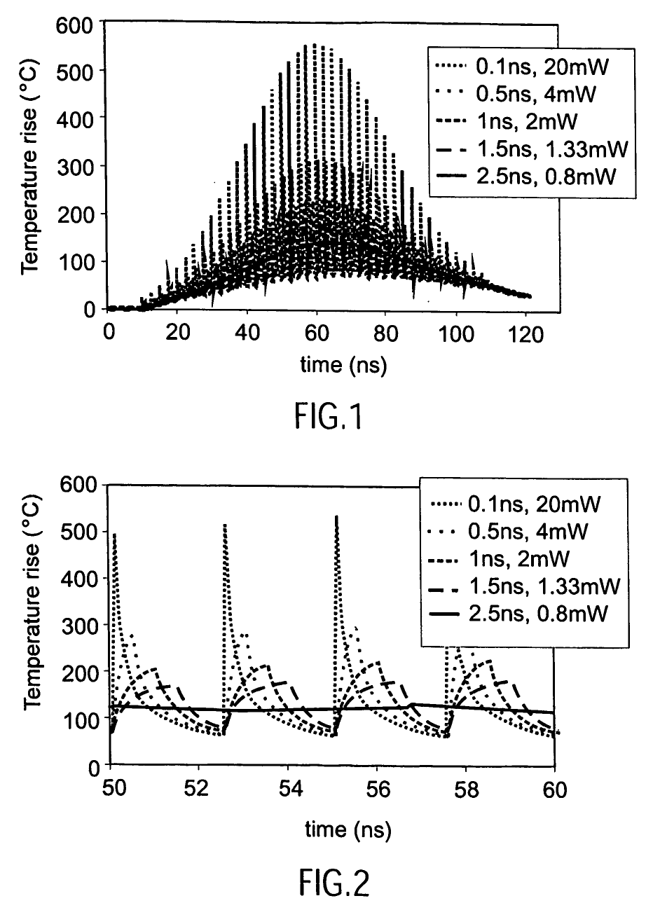

FIG. 1 shows typical temperature-time responses to a pulsed laser power strategy,

FIG. 2 shows a zoom-in of the temperature-time responses shown in FIG. 1,

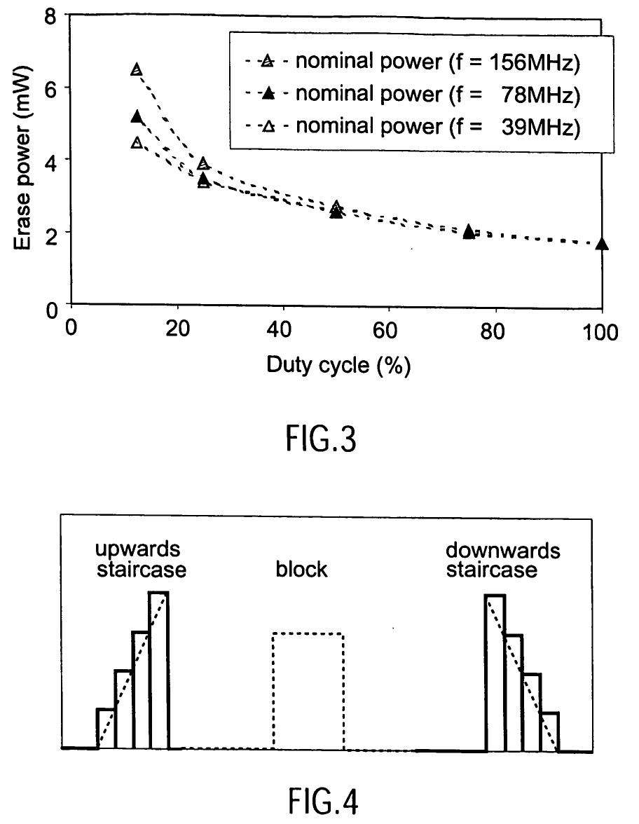

FIG. 3 shows the calculated minimum erase power that caused complete erase as a function of the imposed duty cycle of the erase pulses,

FIG. 4 shows three different pulse shapes,

FIG. 5 shows temperature-time responses to a pulsed erase strategy for the three different pulse shapes shown in FIG. 4,

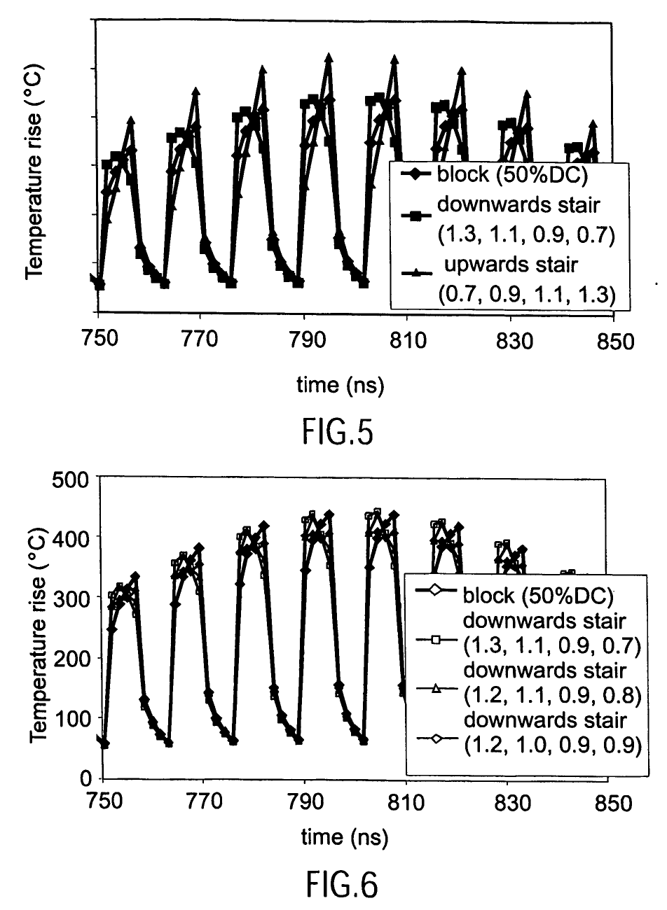

FIG. 6 shows temperature-time responses to a pulsed erase strategy for further pulse shapes,

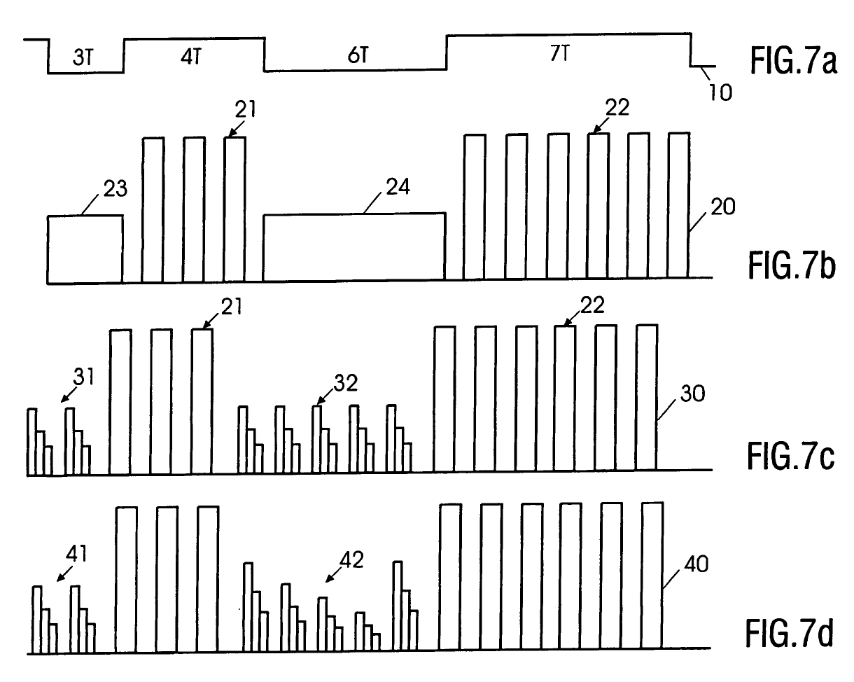

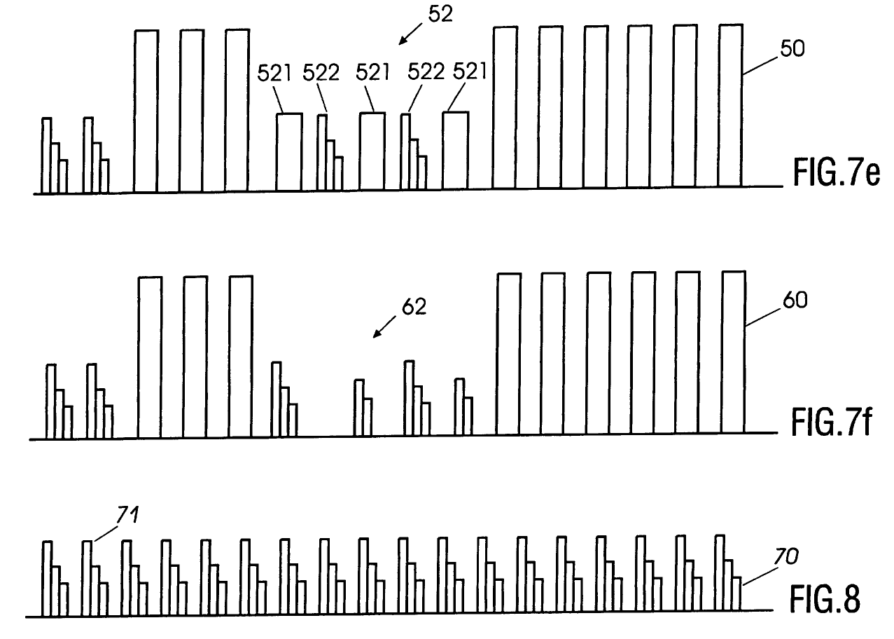

FIG. 7 shows diagrams illustrating the time-dependence of the data signal (FIG. 7a) and different embodiments of a control signal (FIGS. 7b- 7f) according to the invention for controlling the power level of the radiation beam during recording and

FIG. 8 shows a diagram illustrating an embodiment of a control signal according to the invention for controlling the power level of the radiation beam during reading.

A pulse-shaped erase level, so-called pulsed erase, has already been proposed in the initial phase of the Blu-ray Disc system (in the former DVR land/groove system). A pulsed erase strategy appeared to work properly for fast-growth materials (for example doped SbTe compositions). A pulsed erase leads to a more or less DC-kind of temperature rise with superimposed temperature peaks caused by the erase pulses. This is illustrated in FIG. 1 in which the temperature response to a pulsed laser strategy is shown for 5 different pulse lengths (indicated in ns) with constant energy content but variable duty cycles. The pulse length of 2.5 ns leads to 100% DC (constant DC power).

A magnification of part of FIG. 1 is shown in FIG. 2 to elucidate the differences in pulse response. The crystallization speed of a phase-change material is temperature-dependent. A long constant but moderate temperature rise may lead to complete erasure (the amorphous mark is completely erased) but a pulsed strategy with temperature peaks sufficiently high and long can also lead to complete erasure.

Mark formation and erasure simulations were performed to study the effect of pulsed erasure for an SFFO kind of system. In a first cycle, a mark was written with a pulse strategy. In a second cycle, the mark was erased with a pulsed erase strategy. The pulse duty cycle was varied between 12.5% and 100% (a duty cycle of 100% corresponds to a constant erase power, DC erase), the pulse frequency was varied between 39 and 156 MHz. In FIG. 3, the minimum erase pulse powers needed to obtain complete erase of the amorphous marks present in the disc are shown as a function of the imposed duty cycle. It can be seen that a higher pulse frequency, i.e. shorter pulses, leads to a higher erase power to induce complete erasure. In that case, the pulse temperature is higher, but the time in which a high temperature is experienced is accordingly shorter.

To further reduce the duty cycle, it is proposed according to the present invention to use erase pulses with an erase power level that is decreasing with time, such as a downward staircase. Such a pulse shape is illustrated in FIG. 4c together with two other pulse shape examples, namely a pulse with an upward staircase (FIG. 4a) and a block-shaped pulse (FIG. 4b). The corresponding temperature-time responses are illustrated in FIG. 5 for SFFO-conditions (linear velocity LV=2.09 m/s, numerical aperture NA=0.85, wavelength of laser light lambda=405 nm). A block-shaped pulse typically results in a steady temperature increase, which is very characteristic for a pulse response (although the linear recording velocity is now involved). An upwards staircase leads to a somewhat delayed temperature increase, causing an even steeper temperature rise. A downwards staircase leads to the opposite and wanted behavior, namely a more or less constant and lower temperature in time. This behavior can be understood from the insight that a high laser power is applied when the temperature of the medium is low. After the first time increment in which the laser power is on, the stack heats up, and the laser power is reduced accordingly to compensate for the increasing temperature. This leads to downwards staircase pulse shape proposed according to the present invention.

More simulation results are shown in FIG. 6. In this case, the power levels in the downward staircase are varied, in one case even leading to an almost flat temperature-time profile. A great advantage of such a constant temperature level during erasure is that the crystallization time (duration of erase pulses) can be optimized with respect to the maximum crystallization speed of the used phase-change material. It is clear that such optimization results in a further reduction of the length of the erase pulse, and thus system power consumption, without sacrificing the erasability of the disc.

Finally, such a downwards staircase pulse shape or, more generally, an erase pulse having a decreasing power level, can also be used to improve the repeated read performance of a disc. In that case, the total read power can be reduced without sacrificing the signal-to-noise ratio of the signals received from the disc. It is well known that a reduced read power improves the number of read cycles, which means that deterioration of the written marks is severely postponed.

FIG. 7 shows diagrams of a digital data signal 10 and different embodiments of a control signal 20, 30, 40, 50, 60, as used in the method according to the present invention. FIG. 7a gives the value of the digital data signal 10 as a function of time, the value of the signal representing information to be recorded. In the example shown the data signal 10 subsequently comprises a 3T space, a 4T mark, a 6T space and a 7T mark, T representing the period of a reference/data clock, also called the channel bit period.

The data is written in an optical rewritable record carrier having an information layer which information layer has a phase reversibly changeable between a crystalline phase and an amorphous phase. The marks representing the data are written along a track in the information layer by irradiating it with a pulsed radiation beam in order to write the marks. The marks representing the data are erased along a track in the information layer by irradiating it with a pulsed radiation beam in order to erase the marks. During rewriting erase pulses are applied in between write pulses to erase the old marks.

An embodiment of a control signal 20 according to prior art is shown in FIG. 7b. Therein, the control signal uses an N−1 write strategy, i.e. the number of write pulses for writing a mark having a time length of NT is N−1, i.e. three write pulses 21 are applied for writing the 4T mark and 6 write pulses 22 are applied for writing the 7T mark. Previously written marks are erased during writing the spaces by applying block-shaped erase pulses 23, 24 having a constant erase power level.

According to the present invention for erasing written marks sequences of erase pulses are used instead of only a single block-shaped erase pulse as shown in FIG. 7b. The number of erase pulses in said sequences may, similarly like the number of write pulses in a sequence of write pulses, be (N−1)T for writing a space having a time length of NT. However, the number of erase pulses could also be different, such as N. Furthermore, at least one of the erase pulses in a sequence of erase pulses has an erase power level which is decreasing with time. Different embodiment of a control signal according to the invention showing such erase pulses are shown in FIG. 7c to 7f.

In FIG. 7c the control signal 30 comprises sequences 31, 32 of 2 or 5, respectively, erase pulses each having an identical shape in the form of a downwards staircase. FIG. 7d shows an embodiment of a control signal 40 where the erase pulses in the sequence 42 have a different height, i.e. the step sizes as well as the power levels of the individual portions of each erase pulse may have different levels. However, as also shown in FIG. 7d this must not be applied to all erase pulse sequences since the erase pulse sequence 41 shows identical erase pulses.

Furthermore, as shown in the control signal 50 of FIG. 7e not all erase pulses must have a downwards staircase shape. It is as well possible that single erase pulses 521 of an erase pulse sequence 52 have a constant erase power level and have a block-shaped form, while other erase pulses 522 have a downwards staircase form. Even more, it is possible that the erase pulses in an erase pulse sequence 62, as shown in FIG. 7f for control signal 60, have different increments or that a single erase pulse is even missing.

The embodiment shown in FIG. 7c is a way to minimize power consumption without sacrificing the erasability of the disc. An advantage of the reduction in power amplitude (from erase pulse 1 to 4) may be the partial compensation of the heating up of the recording stack. Heat diffusion through the stack will heat up a part of the disc ahead of the laser spot. In that case less power is needed to achieve the optimum re-crystallisation temperature (for erasure of marks). The last erase pulse with higher amplitude is then for example applied to preheat the stack to enable writing of the next mark. In that case less write power is needed. Such a strategy may be beneficial for high-speed recording. The embodiment shown in FIG. 7e is a combination between block-shaped erase pulses and the staircase erase pulses. In this case less electrical power is saved, but the erasibility may probably be improved. Such a pulse strategy may be beneficial for inter-company overwrite. For example if data written in a different device is overwritten in the current drive. The possible difference in mark size (the old data may be written with higher power, leading to a larger mark width) may be compensated for by extra power.

The embodiment shown in FIG. 7f may be interpreted as a thermally balance strategy, taking into account the write pulses applied before and after the train with erase pulses.

FIG. 8 shows a diagram illustrating an embodiment of a control signal 70 according to the invention for controlling the power level of the radiation beam during reading, by use of which the information signal 10 (FIG. 7a) can be read. As shown the control signal 70 comprises a sequence of identical read pulses 71 having a read power level which is decreasing with time in the form of a staircase. However, it is also possible that the read pulses have other and/or different shapes similar as it is explained above and shown in FIG. 7. In this way, the total read power can be reduced without sacrificing the signal-to-noise ratio of the signals received from the record carrier.

It should be noted that the present invention is not limited to the embodiments shown in FIGS. 7 and 8, but many variations are possible. By using erase pulses/read pulses in a erase pulse sequence or read pulse sequence, respectively, of which at least one has an erase power level or read power level, respectively, which is decreasing with time a significant reduction of power consumption, which is at least important for portable optical drives, such as an SFFO drive, can be achieved.

1. A method of recording data in the form of marks and for erasing recorded marks in an information layer of a record carrier by irradiating the information layer by means of a pulsed radiation beam, a recorded mark being erased by a sequence of erase pulses (31, 32), said information layer having a phase reversibly changeable between a crystalline phase and an amorphous phase,
characterized in that at least one of the erase pulses in said sequence of erase pulses (31, 32) has an erase power level which is decreasing with time.

2. Method as claimed in claim 1,
wherein at least one of the erase pulses in said sequence of erase pulses (31, 32) consists of n portions, n being an integer number larger than 1, the i-th portion having an i-th erase power level, i being an integer number in the range between 1 and n, the i-th portion preceding the (i+1)-th portion, and wherein the i-th erase power level is higher than the (i+1)-th erase power level.

3. Method as claimed in claim 2,
wherein at least one of the erase pulses in the said sequence of erase pulses (31, 32) consists of n portions of substantially the same duration.

4. Method as claimed in claim 1,
wherein at least one of the erase pulses in said sequence of erase pulses has an erase power level which is continuously decreasing with time.

5. Method as claimed in claim 1,
wherein all erase pulses in said sequence of erase pulses (31, 32) have an erase power level which is decreasing with time.

6. Method as claimed in claim 1,
wherein all erase pulses in one sequence of erase pulses (31, 32) are identical.

7. Method as claimed in claim 1,
wherein the front portions of the erase pulses (42) in one sequence of erase pulses have different erase power levels.

8. Method as claimed in claim 1,
wherein the time dependency of the erase power level of the at least one erase pulse is dependent on properties of the record carrier and the erasing velocity.

9. An optical recording device for recording data in the form of marks and for erasing recorded marks in an information layer of a record carrier by irradiating the information layer with a pulsed radiation beam, said information layer having a phase reversibly changeable between a crystalline phase and an amorphous phase, the device comprising a radiation source for providing the radiation beam and a control unit operative for controlling the power of the radiation beam and for providing a sequence of write pulses (21, 22) for recording the marks and a sequence of erase pulses (31, 32) for erasing recorded marks,
characterized in that the control unit is operative for controlling the power of the radiation beam for erasing a recorded mark such that at least one of the erase pulses in said sequence of erase pulses (31, 32) has an erase power level which is decreasing with time.

10. A method of reading data recorded in the form of marks and spaces in an information layer of a record carrier by irradiating the information layer by means of a sequence of read pulses (71) of a pulsed radiation beam, said information layer having a phase reversibly changeable between a crystalline phase and an amorphous phase,
characterized in that at least one of the read pulses in said sequence of read pulses (71) has an read power level which is decreasing with time.

11. Method as claimed in claim 10,
wherein at least one of the read pulses in said sequence of read pulses (71) consists of n portions, n being an integer number larger than 1, the i-th portion having an i-th read power level, i being an integer number in the range between 1 and n, the i-th portion preceding the (i+1)-th portion, and wherein the i-th read power level is higher than the (i+1)-th read power level.

12. Method as claimed in claim 11,
wherein at least one of the read pulses in the said sequence of read pulses (71) consists of n portions of substantially the same duration.

13. Method as claimed in claim 10,
wherein at least one of the read pulses in said sequence of read pulses (71) has a read power level which is continuously decreasing with time.

14. A method as claimed in claim 10,
wherein all read pulses in said sequence of read pulses (71) have a read power level which is decreasing with time.

15. Method as claimed in claim 10,
wherein all read pulses in one sequence of read pulses (71) are identical.

16. Method as claimed in claim 10,
wherein the front portions of the read pulses in one sequence of read pulses have different read power levels.

17. Method as claimed in claim 10,
wherein the time dependency of the read power level of the at least one read pulse is dependent on properties of the record carrier and the reading velocity.

18. An optical recording device for reading data recorded in the form of marks and spaces in an information layer of a record carrier by irradiating the information layer by means of a sequence of read pulses (71) of a pulsed radiation beam, said information layer having a phase reversibly changeable between a crystalline phase and an amorphous phase, the device comprising a radiation source for providing the radiation beam and a control unit operative for controlling the power of the radiation beam and for providing a sequence of read pulses for reading the information,
characterized in that the control unit is operative for controlling the power of the radiation beam for reading the information such that at least one of the read pulses in said sequence of read pulses (71) has a read power level which is decreasing with time.
